(19) United States
(12) Patent Application Publication
(10) Pub. No.: US 2016/0286138 A1
(43) Pub. Date: Sep. 29, 2016

(54) APPARATUS AND METHOD FOR STITCHING PANORAMAIC VIDEO

(71) Applicant: ELECTRONICS AND TELECOMMUNICATIONS RESEARCH INSTITUTE, Daejeon (KR)

(72) Inventor: Yong Sun KIM, Sejong-si (KR)

(21) Appl. No.: 15/081,144

(22) Filed: Mar. 25, 2016

(30) Foreign Application Priority Data
Mar. 27, 2015 (KR) 10-2015-0043209

(51) Int. Cl. H04N 5/265; H04N 1/60; G06K 9/62; H04N 5/232; G06K 9/46

(52) U.S. Cl. CPC H04N 5/265; H04N 5/23238; G06K 9/4604; G06K 9/6201; H04N 1/6027

(57) ABSTRACT

An apparatus and method for stitching a panoramic video. The method includes acquiring a plurality of video streams from a plurality of cameras, selecting a reference image frame set, which is a set of still image frames captured at a first point in time, from the plurality of video streams, calculating stitching parameters including a camera parameter and a color correction coefficient based on correspondence relationships between feature points extracted from the reference image frame set, and generating a panoramic video by applying the stitching parameters to another image frame set, which is a set of still image frames captured at a second point in time.

### CROSS-REFERENCE TO RELATED APPLICATION

This application claims priority to and the benefit of Korean Patent Application No, 10-2015-0043209, filed on Mar. 27, 2015, the disclosure of which is incorporated herein by reference in its entirety.

### BACKGROUND

1. Field of the Invention

The present invention relates to image processing, and more particularly, to an apparatus and method for stitching a panoramic video.

2. Description of Related Art

Research on a stitching method of combining several still images acquired from one or more cameras into one panoramic image having a large angle of view is under way.

In general, panoramic images are involved in generation of images with particularly wide fields of view. Panoramic images are obtained by capturing a field of view equal to or wider than the field of view of human eyes typically ranging from 75 degrees to about 160 degrees. Panoramas indicating such images provide expansive or perfect fields of view. In many cases, a panoramic image is expressed as a wide strip.

Generation of a panoramic image frequently involves capturing and matching overlapping image frames or “stitching” overlapping edges of the frames together.

In particular, with the development of virtual reality or augmented reality technology, a demand for a video having a view angle of 360 degrees based on actual photography is increasing. The simplest method of producing a panoramic video is to apply an existing still image stitching method to each frame of a video.

When several cameras capturing videos do not separately move but are installed in one structure, respective frames of a panoramic video may share the same stitching parameter. The stitching parameter includes rotation, focal lengths, and color correction coefficients of the cameras.

In this case, the stitching parameter may be calculated using a still image set corresponding to a first image frame and may be applied to other image frames, so that video stitching may be implemented.

According to related art, a large amount of computation is required to stitch still images for each frame, and thus it is not possible to obtain stitching results in real time.

Also, when a stitching parameter of a specific image frame set is shared with another image frame, a stitching error of the specific image frame set continuously affects the other image frame.

Further, when the cameras are unexpectedly moved during video capturing due to looseness or collision of the structure, the quality of video stitching is not ensured.

### SUMMARY OF THE INVENTION

The present invention is directed to providing a fast video stitching method and apparatus that combines a plurality of video streams acquired from a plurality of cameras installed in a structure into one wide field-of-view panoramic video.

According to an aspect of the present invention, there is provided a method of stitching a panoramic video, the method including: acquiring a plurality of video streams from a plurality of cameras; selecting a reference image frame set, which is a set of still image frames captured at a first point in time, from the plurality of video streams; calculating stitching parameters including a camera parameter and a color correction coefficient based on correspondence relationships between feature points extracted from the reference image frame set; and generating a panoramic video by applying the stitching parameters to another image frame set, which is a set of still image frames captured at a second point in time.

In an exemplary embodiment, the selecting of the reference image frame set may include: generating point in time-specific image frame sets by combining still image frames captured at the same time in the plurality of video streams; extracting feature points from still image frames constituting each of the image frame sets; and selecting an image frame set having a largest number of extracted feature points as the reference image frame set.

In another exemplary embodiment, the selecting of the reference image frame set may include: generating point in time-specific image frame sets by combining still image frames captured at the same time in the plurality of video streams; extracting feature points from still image frames constituting each of the image frame sets; selecting image frame sets whose extracted feature points number a previously set minimum feature point number or more; and selecting an image frame set having a largest number of extracted feature points from among the selected image frame sets as the reference image frame set.

The calculating of the stitching parameters may include: extracting the feature points from the respective still image frames constituting the reference image frame set; matching feature points between the still image frames and calculating correspondence relationships; calculating the camera parameter based on the correspondence relationships; and calculating the color correction coefficient for equalizing colors of regions overlapping when the still image frames are matched based on the camera parameter.

Here, the calculating of the camera parameter may include: selecting a group of camera parameter candidates resulting in least square errors from at least three feature correspondence points; and applying the camera parameter candidate group to another feature correspondence point and selecting a camera parameter resulting in a least square error in the camera parameter candidate group.

The generating of the panoramic video may include: converting the still image frames in an x-y coordinate system into converted images in a panoramic image coordinate system using the camera parameter; and performing color correction by applying the color correction coefficient to the converted images, and then combining the still image frames by summing weights of overlapping regions between the converted images.

The method may further include updating the stitching parameters.

In an exemplary embodiment, the updating of the stitching parameters may include: generating an update signal at predetermined periods; extracting feature points from respective still image frames constituting an image frame set corresponding to a point in time at which the update signal is generated; matching feature points between the still image frames and calculating correspondence relationships; calculating a camera parameter based on the correspondence relationships; and calculating the color correction coefficient for equalizing colors of regions overlapping when the still image frames are matched based on the camera parameter.

In another exemplary embodiment, the updating of the stitching parameters may include: calculating a movement between a previous still image frame (t−1) and a current still image frame (t) in each of the plurality of video streams; when a size of a first movement between a previous still image frame (t−1) and a current still image frame (t) in a first video stream is larger than a previously set first threshold, calculating a second movement between a previous still image frame (t−1) and a current still image frame (t) in a second video stream; and when a difference in size between the first movement and the second movement is larger than a previously set second threshold, generating an update signal.

The updating of the stitching parameters may further include generating the update signal when the difference in size between the first movement and the second movement is smaller than the previously set second threshold and a smaller one of sizes of the first movement and the second movement is larger than a previously set third threshold.

According to another aspect of the present invention, there is provided an apparatus for stitching a panoramic video, the apparatus including: a video acquisition unit configured to acquire a plurality o parameter calculation f video streams from a plurality of cameras; a reference image frame set selection unit configured to select a reference image frame set, which is a set of still image frames captured at a first point in time, from the plurality of video streams; a stitching parameter calculation unit configured to calculate stitching parameters including a camera parameter and a color correction coefficient based on correspondence relationships between feature points extracted from the reference image frame set; and a panoramic video generation unit configured to generate a panoramic video by applying the stitching parameters to another image frame set, which is a set of still image frames captured at a second point in time.

In an exemplary embodiment, the reference image frame set selection unit may generate point in time-specific image frame sets by combining still image frames captured at the same time in the plurality of video streams, extract feature points from still image frames constituting each of the image frame sets, and select an image frame set having a largest number of extracted feature points as the reference image frame set.

In another exemplary embodiment, the reference image frame set selection unit may generate point in time-specific image frame sets by combining still image frames captured at the same time in the plurality of video streams, extract feature points from still image frames constituting each of the image frame sets, select image frame sets whose extracted feature points number a previously set minimum feature point number or more, and select an image frame set having a largest number of extracted feature points from among the selected image frame sets as the reference image frame set.

The stitching parameter calculation unit may extract the feature points from the respective still image frames constituting the reference image frame set, match feature points between the still image frames to calculate correspondence relationships, calculate the camera parameter based on the correspondence relationships, and calculate the color correction coefficient for equalizing colors of regions overlapping when the still image frames are matched based on the camera parameter.

The stitching parameter calculation unit may select a group of camera parameter candidates resulting in least square errors from at least three feature correspondence points, and apply the camera parameter candidate group to another feature correspondence point to select a camera parameter resulting in a least square error in the camera parameter candidate group.

The panoramic video generation unit may convert the still image frames in an x-y coordinate system into converted images in a panoramic image coordinate system using the camera parameter, perform color correction by applying the color correction coefficient to the converted images, and then combine the still image frames by summing weights of overlapping regions between the converted images.

The apparatus may further include a stitching parameter update unit configured to update the stitching parameters.

The stitching parameter update unit may include: an update signal generation unit configured to generate an update signal, an image feature extraction unit configured to extract feature points from respective still image frames constituting an image frame set corresponding to a point in time at which the update signal is generated; a feature correspondence relationship calculation unit configured to match feature points between the still image frames and calculate correspondence relationships; a camera parameter calculation unit configured to calculate the camera parameter based on the correspondence relationships; and a color correction coefficient calculation unit configured to calculate the color correction coefficient for equalizing colors of regions overlapping when the still image frames are matched based on the camera parameter.

In an exemplary embodiment, the update signal generation unit may generate the update signal at previously set periods.

In another exemplary embodiment, the update signal generation unit may include: a first movement calculation unit configured to calculate a movement between a previous still image frame (t−1) and a current still image frame (t) in each of the plurality of video streams; a second movement calculation unit configured to calculate a second movement between a previous still image frame (t−1) and a current still image frame (t) in a second video stream when a size of a first movement between a previous still image frame (t−1) and a current still image frame (t) in a first video stream is larger than a previously set first threshold; and a movement determination unit configured to determine the first movement and the second movement as abnormal movements when a difference in size between the first movement and the second movement is larger than a previously set second threshold, or when the difference in size between the first movement and the second movement is smaller than the previously set second threshold and a smaller one of sizes of the first movement and the second movement is larger than a previously set third threshold.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a block diagram showing a configuration of an apparatus for stitching a panoramic video according to a first exemplary embodiment of the present invention;

FIG. 2 is a block diagram showing a configuration of a reference image frame set selection unit of FIG. 1;

FIG. 3 is a block diagram showing a configuration of a stitching parameter calculation unit of FIG. 1;

FIG. 4 is a block diagram showing a configuration of a panoramic video generation unit of FIG. 1;

FIG. 5 is a block diagram showing a configuration of a stitching parameter update unit of FIG. 1;

FIG. 6 is a block diagram showing a configuration of an update signal generation unit of FIG. 5;

FIG. 7 is a block diagram showing a configuration of an apparatus for stitching a panoramic video according to a second exemplary embodiment of the present invention;

FIG. 8 is a flowchart illustrating a method of stitching a panoramic video according to the first exemplary embodiment of the present invention, and

FIG. 9 is a flowchart illustrating a method of stitching a panoramic video according to the second exemplary embodiment of the present invention.

FIG. 10 is a view illustrating an example of a computer system in which a method for stitching a panoramic video according to an embodiment of the present invention is performed.

### DETAILED DESCRIPTION OF EXEMPLARY EMBODIMENTS

Advantages and features of the present invention and a method of achieving the same will be more clearly understood from embodiments described below in detail with reference to the accompanying drawings. However, the present invention is not limited to the following embodiments and may be implemented in various different forms. The embodiments are provided merely for complete disclosure of the present invention and to fully convey the scope of the invention to those of ordinary skill in the art to which the present invention pertains. The present invention is defined only by the scope of the claims. Meanwhile, the terminology used herein is for the purpose of describing the embodiments and is not intended to be limiting of the invention. As used in this specification, the singular form of a word includes the plural unless the context clearly indicates otherwise. The term “comprise” or “comprising,” when used herein, does not preclude the presence or addition of one or more components, steps, operations, and/or elements other than stated components, steps, operations, and/or elements.

Hereinafter, exemplary embodiments of the present invention will be described in detail with reference to the accompanying drawings. Throughout the specification, like reference numerals refer to like elements. In describing the present invention, any detailed description of known technology or function will be omitted if it is deemed that such a description will obscure the gist of the invention unintentionally.

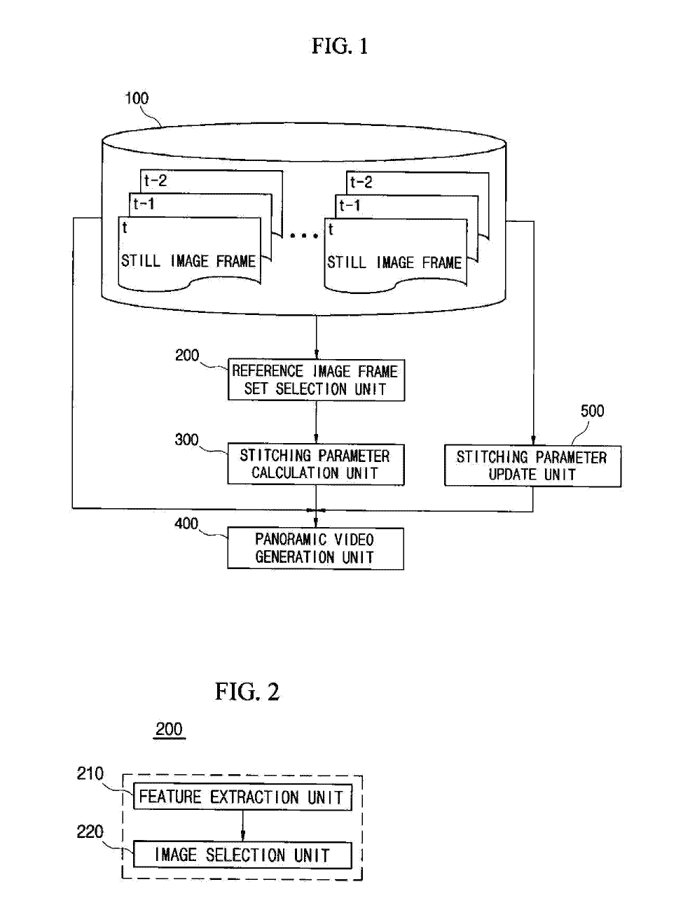

FIG. 1 is a block diagram showing a configuration of an apparatus for stitching a panoramic video according to a first exemplary embodiment of the present invention.

Referring to FIG. 1, the apparatus for stitching a panoramic video according to the first exemplary embodiment of the present invention includes a video acquisition unit 100, a reference image frame set selection unit 200, a stitching parameter calculation unit 300, a panoramic video generation unit 400, and a stitching parameter update unit 500.

The video acquisition unit 100 acquires a plurality of video streams from a plurality of cameras.

In an exemplary embodiment of the present invention, the plurality of cameras are installed in a structure to photograph a specific target region in 360 degrees. Images acquired by the respective cameras have overlapping regions, and the structure may move. When the structure is drastically moved or subjected to a vibration, a collision, etc., the plurality of cameras may move at the installed positions.

The respective cameras are synchronized, or video-synchronized by sound and image using software.

In other words, the plurality of cameras each photograph the specific target region from different viewpoints, and generate a plurality of video streams of the specific target region from the different viewpoints.

In an exemplary embodiment of the present invention, targets of stitching are still image frames captured at the same point in time among still image frames constituting the video streams of the plurality of viewpoints. When N video streams captured with N cameras are generated, an image frame set consisting of N still image frames is generated at one point in time, and the image frame set is a target of stitching.

The reference image frame set selection unit 200 selects a reference image frame set that is a target of stitching parameter calculation from among the plurality of image frame sets consisting of a plurality of still image frames. Here, the reference image frame set denotes an image frame set that is the most appropriate for video stitching. In other words, by applying stitching parameters calculated from the image frame set that is the most appropriate for video stitching to another image frame set, it is possible to increase the probability of success in video stitching.

A configuration of the reference image frame set selection unit 200 will be described with reference to FIG. 2. FIG. 2 is a block diagram showing a configuration of a reference image frame set selection unit of FIG. 1.

Referring to FIG. 2, the reference image frame set selection unit 200 includes a feature extraction unit 210 and an image selection unit 220.

The feature extraction unit 210 extracts feature points from still image frames constituting each of the plurality of image frame sets.

Feature points are required to be repeatedly detected even in an image which has been subjected to various geometric transforms, such as movement, scaling, and rotation. Mainly, points having significant local changes are appropriate for use as feature points, and it is necessary to rapidly detect such points for real-time application.

According to an exemplary embodiment of the present invention, it is possible to extract features using corners, edges, etc. of an image, and to this end, extraction methods, such as feature from accelerated segment test (FAST), scale-invariant feature transform (SIFT), speeded up robust features (SURF), binary robust independent elementary features (BRIEF), and binary robust invariant scalable keypoints (BRISK), may be used. These merely correspond to one exemplary embodiment for feature extraction, and the present invention is not limited thereto.

The image selection unit 220 selects a reference image frame set that is the most appropriate for video stitching based on the number of feature points extracted by the feature extraction unit 210.

In an exemplary embodiment, the image selection unit 220 selects an image frame set having the largest number of extracted feature points among the plurality of image frame sets as the reference image frame set.

In another exemplary embodiment, the image selection unit 220 selects image frame sets whose extracted feature points number a previously set minimum feature point number or more and selects an image frame set having the largest number of extracted feature points from among the selected image frame sets as the reference image frame set.

The stitching parameter calculation unit 300 calculates stitching parameters including camera parameters and a color correction coefficient based on correspondence relationships between feature points extracted from the reference image frame set.

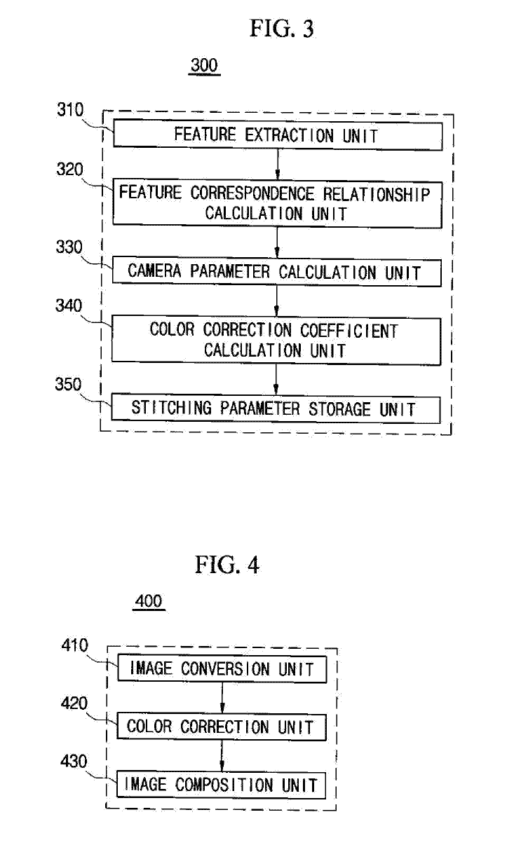

A configuration of the stitching parameter calculation unit 300 will be described below with reference to FIG. 3. FIG. 3 is a block diagram showing a configuration of a stitching parameter calculation unit of FIG. 1.

Referring to FIG. 3, the stitching parameter calculation unit 300 includes a feature extraction unit 310, a feature correspondence relationship calculation unit 320, a camera parameter calculation unit 330, a color correction coefficient calculation unit 340, and a stitching parameter storage unit 350.

The feature extraction unit 310 extracts feature points from the respective still image frames constituting the reference image frame set. As described above with reference to FIG. 2, the feature extraction unit 310 may extract features using corners, edges, etc. of an image and use various feature extraction methods, such as FAST and BRISK.

The feature correspondence relationship calculation unit 320 matches feature points between the still image frames constituting the reference image frame set and calculates correspondence relationships.

The camera parameter calculation unit 330 calculates the camera parameters based on the inter-feature correspondence relationships calculated by the feature correspondence relationship calculation unit 320.

The camera parameters include an intrinsic parameter and an extrinsic parameter, and a relationship with an image and a relationship with an actual space are defined by these parameters.

For example, the intrinsic parameter may be a focal length, a pixel at the image center, a pixel aspect ratio, a screen aspect ratio, the degree of radial distortion, etc., and the extrinsic parameter may be rotation about the center of a camera, movement with respect to the center of a camera, etc.

The camera parameter calculation unit 330 selects a group of camera parameter candidates resulting in least square errors from at least three feature correspondence points, and applies the camera parameter candidate group to another feature correspondence point to select a camera parameter resulting in the least square error in the camera parameter candidate group.

The color correction coefficient calculation unit 340 calculates the color correction coefficient that equalizes colors of regions overlapping when the still image frames are matched based on the camera parameters.

The camera parameters calculated by the camera parameter calculation unit 330 and the color correction coefficient calculated by the color correction coefficient calculation unit 340 are stored in the stitching parameter storage unit 350 as stitching parameters.

The panoramic video generation unit 400 generates a panoramic video by applying the stitching parameters calculated by the stitching parameter calculation unit 300 to another image frame set. At this time, still image frames to which the stitching parameters are applied include a previous frame (t−1) and a subsequent frame (t+1) in a time axis with respect to a reference image frame (t) of the reference image frame set.

A configuration of the panoramic video generation unit 400 will be described below with reference to FIG. 4. FIG. 4 is a block diagram showing a configuration of a panoramic video generation unit of FIG. 1.

The panoramic video generation unit 400 includes an image conversion unit 410, a color correction unit 420, and an image composition unit 430.

The image conversion unit 410 converts still image frames in an x-y coordinate system into converted images in a panoramic image coordinate system using the camera parameters.

The color correction unit 420 performs color correction by applying the color correction coefficient to the converted images.

The image composition unit 430 combines the still image frames by summing weights of overlapping regions between the converted images.

The stitching parameter update unit 500 updates the stitching parameters when an update signal is generated regularly or irregularly during generation of a panoramic video.

For example, while video stitching is performed, the stitching parameters may be changed by displacement of a camera or a change in scene. According to an exemplary embodiment of the present invention, the stitching parameter update unit 500 may improve video stitching performance by calculating the stitching parameters again from the image frame set and updating the stitching parameters when the update signal is generated regularly or irregularly. Since generation of a panoramic video and updating of the stitching parameters are processed in parallel, it is possible to prevent a reduction in a calculation rate per frame.

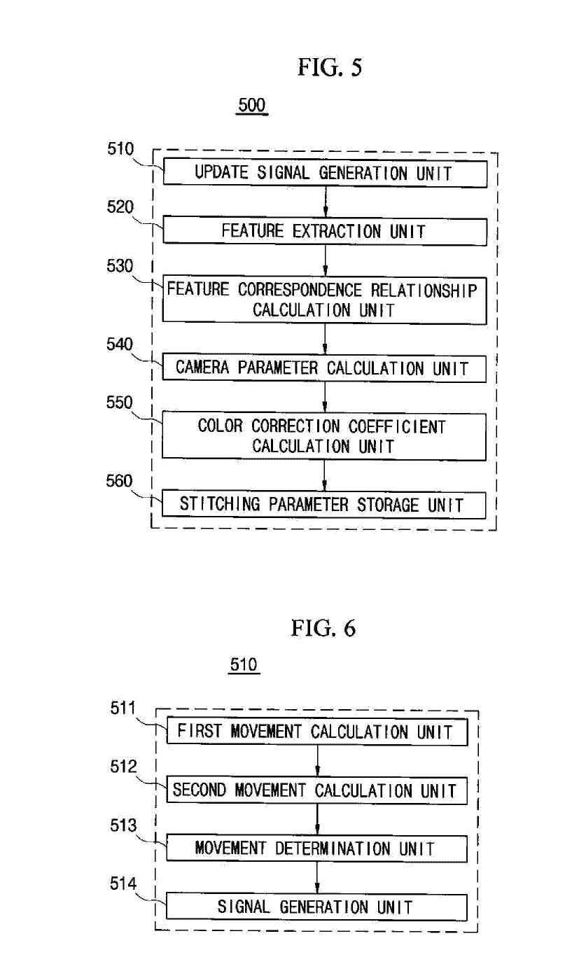

A configuration of the stitching parameter update unit 500 will be described below with reference to FIG. 5. FIG. 5 is a block diagram showing a configuration of a stitching parameter update unit of FIG. 1.

Referring to FIG. 5, the stitching parameter update unit 500 includes an update signal generation unit 510, a feature extraction unit 520, a feature correspondence relationship calculation unit 530, a camera parameter calculation unit 540, a color correction coefficient calculation unit 550, and a stitching parameter storage unit 560.

In an exemplary embodiment, the update signal generation unit 510 may generate the update signal at previously set periods.

In another exemplary embodiment, the update signal generation unit 510 may irregularly generate the update signal. FIG. 6 shows an example of a configuration for generating irregular update signals.

Referring to FIG. 6, the update signal generation unit 510 includes a first movement calculation unit 511, a second movement calculation unit 512, a movement determination unit 513, and a signal generation unit 514.

The first movement calculation unit 511 calculates a movement between a previous still image frame (t−1) and a current still image frame (t) in each of the plurality of video streams.

When a size of a movement (referred to as “first movement” below) between a previous still image frame and a current still image frame calculated in a specific video stream (referred to as “first video stream” below) is larger than a previously set first threshold, the second movement calculation unit 512 calculates a movement (referred to as “second movement” below) between a previous still image frame and a current still image frame of a video stream (referred to as “second video stream” below) other than the first video stream.

The movement determination unit 513 compares the sizes of the first movement and the second movement. When a difference in size between the first movement and the second movement is smaller than a previously set second threshold, that is, when a movement is uniformly maintained over all the video streams, it is possible to determine that the structure in which the cameras are installed has been moved and positional relationships between the plurality of cameras are maintained. Therefore, in this case, no update signal is generated.

When the difference in size between the first movement and the second movement is larger than the previously set second threshold, it is possible to determine that the positional relationships between the cameras in the structure are changed and the first movement and the second movement are abnormal movements. At this time, the movement determination unit 513 transfers a command for the signal generation unit 514 to generate the update signal to the signal generation unit 514.

Also, even if the difference in size between the first movement and the second movement is smaller than the previously set second threshold, when a smaller one of the sizes of the first movement and the second movement is larger than a previously set third threshold, the movement determination unit 513 determines that a photographed scene has been changed or the first movement and the second movement are abnormal movements, and transfers the command for the signal generation unit 514 to generate the update signal to the signal generation unit 514.

Referring back to FIG. 5, the feature extraction unit 520 extracts feature points from respective still image frames constituting an image frame set corresponding to a point in time at which the update signal is generated.

The feature correspondence relationship calculation unit 530 matches feature points between the still image frames and calculates correspondence relationships.

The camera parameter calculation unit 540 calculates camera parameters based on the correspondence relationships.

The color correction coefficient calculation unit 550 calculates a color correction coefficient that equalizes colors of regions overlapping when the still image frames are matched based on the camera parameters.

The camera parameters calculated by the camera parameter calculation unit 540 and the color correction coefficient calculated by the color correction coefficient calculation unit 550 are stored in the stitching parameter storage unit 560 as stitching parameters, and the panoramic video generation unit 400 generates a panoramic video by applying the stitching parameters updated by the stitching parameter update unit 500 to another image frame set. At this time, the updated stitching parameters may be applied to a previous frame or a subsequent frame in the time axis with respect to a reference image frame constituting the image frame set corresponding to the point in time at which the update signal is generated.

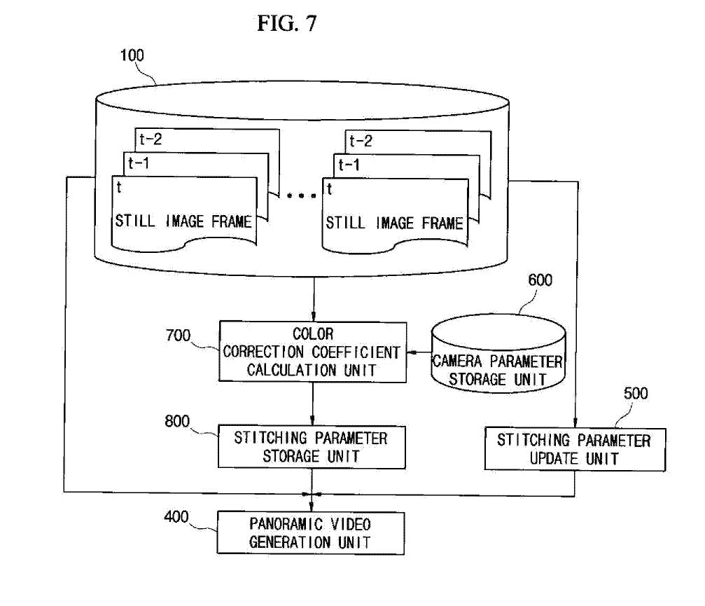

FIG. 7 is a block diagram showing a configuration of an apparatus for stitching a panoramic video according to a second exemplary embodiment of the present invention.

Referring to FIG. 7, the apparatus for stitching a panoramic video according to the second exemplary embodiment of the present invention includes a video acquisition unit 100, a color correction coefficient calculation unit 700, a stitching parameter storage unit 800, a camera parameter storage unit 600, and a stitching parameter update unit 500.

In FIG. 7, like reference numerals will be used for the same components as those of the apparatus for stitching a panoramic video according to the first exemplary embodiment of the present invention described with reference to FIGS. 1 to 6. Only components other than the same components will described.

According to the second exemplary embodiment of the present invention, calibration of cameras installed in a structure is performed in advance, and camera parameters are stored in the camera parameter storage unit 600 in advance.

Since the camera parameters are known in advance, the color correction coefficient calculation unit 700 calculates a color correction coefficient for a reference image frame set or a first image frame set using the already-known camera parameters.

The camera parameters and the color correction coefficient calculated by the color correction coefficient calculation unit 700 are stored in the stitching parameter storage unit 800 as stitching parameters.

The panoramic video generation unit 400 generates a panoramic video by applying the stitching parameters to another image frame set. At this time, still image frames to which the stitching parameters are applied include a previous frame (t−1) and a subsequent frame (t+1) in the time axis with respect to a reference image frame (t) of the reference image frame set.

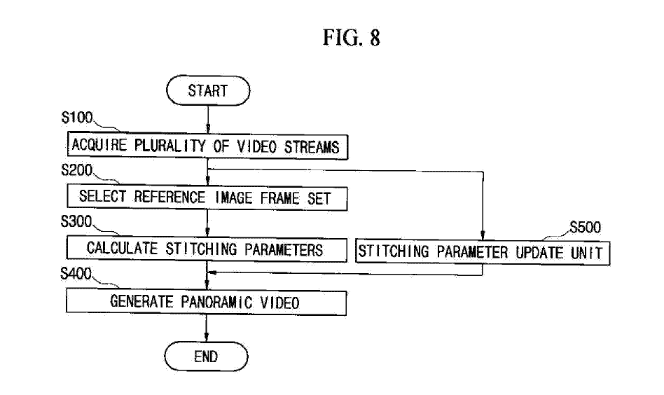

A method of stitching a panoramic video according to the first exemplary embodiment of the present invention will be described below with reference to FIGS. 1 and 8. FIG. 8 is a flowchart illustrating a method of stitching a panoramic video according to the first exemplary embodiment of the present invention.

First, the video acquisition unit 100 acquires a plurality of video streams from a plurality of cameras (S100).

In exemplary embodiments of the present invention, the plurality of cameras each photograph a specific target region from different viewpoints, and generate a plurality of video streams of the specific target region from the different viewpoints.

When N video streams captured with N cameras are generated, each of the video streams consists of a set of a plurality of still image frames (t, t−1, t−2, . . . ).

The reference image frame set selection unit 200 selects a reference image frame set that is a target of stitching parameter calculation from among a plurality of image frame sets consisting of a plurality of still image frames (S200).

Here, the reference image frame set denotes an image frame set that is the most appropriate for video stitching. In other words, by applying stitching parameters calculated from the image frame set that is the most appropriate for video stitching to another image frame set, it is possible to increase the probability of success in video stitching.

In an exemplary embodiment, the reference image frame set selection unit 200 generates point in time-specific image frame sets by combining still image frames captured at the same time in the plurality of video streams, extracts feature points from still image frames constituting each of the image frame sets, and selects an image frame set having the largest number of extracted feature points as the reference image frame set.

In another exemplary embodiment, the reference image frame set selection unit 200 generates point in time-specific image frame sets by combining still image frames captured at the same time in the plurality of video streams, extracts feature points from still image frames constituting each of the image frame sets, selects image frame sets whose extracted feature points number a previously set minimum feature point number or more, and selects an image frame set having the largest number of extracted feature points from among the selected image frame sets as the reference image frame set.

Subsequently, the stitching parameter calculation unit 300 calculates stitching parameters including camera parameters and a color correction coefficient based on correspondence relationships between feature points extracted from the reference image frame set (S300).

The stitching parameter calculation unit 300 extracts feature points from each of still image frames constituting the reference image frame set, matches feature points between the still image frames to calculate the correspondence relationships, calculates the camera parameters based on the correspondence relationships, calculates the color correction coefficient for equalizing colors of regions overlapping when the still image frames are matched based on the camera parameters, and stores the camera parameters and the color correction coefficient as stitching parameters.

For example, the stitching parameter calculation unit 300 may calculate the camera parameters through a process of selecting a group of camera parameter candidates resulting in least square errors from at least three feature correspondence points and applying the camera parameter candidate group to another feature correspondence point to select a camera parameter resulting in the least square error in the camera parameter candidate group.

Subsequently, the panoramic video generation unit 400 generates a panoramic video by applying the stitching parameters calculated in operation S300 to another image frame set (S400). At this time, still image frames to which the stitching parameters are applied include a previous frame (t−1) and a subsequent frame (t+1) in the time axis with respect to a reference image frame (t) of the reference image frame set.

For example, the panoramic video generation unit 400 converts the still image frames in an x-y coordinate system into converted images in a panoramic image coordinate system using the camera parameters, performs color correction by applying the color correction coefficient to the converted images, and then combines the still image frames by summing weights of overlapping regions between the converted images.

Meanwhile, when a regular or irregular update signal is generated, the stitching parameter update unit 500 updates the stitching parameters.

In an exemplary embodiment, when the update signal is generated at previously set periods, the stitching parameter update unit 500 extracts feature points from respective still image frames constituting an image frame set corresponding to a point in time at which the update signal is generated, matches feature points between the still image frames to calculate correspondence relationships, calculates the camera parameters based on the correspondence relationships, calculates the color correction coefficient for equalizing colors of regions overlapping when the still image frames are matched based on the camera parameters, and updates the stitching parameters with the newly calculated camera parameters and the newly calculated color correction coefficient.

In another exemplary embodiment, the update signal may be irregularly generated. For example, the panoramic video generation unit 400 may calculate a movement between a previous still image frame (t−1) and a current still image frame (t) in each of the plurality of video streams, calculate a second movement between a previous still image frame (t−1) and a current still image frame (t) in a second video stream when a size of a first movement between a previous still image frame (t−1) and a current still image frame (t) in a first video stream is larger than a previously set first threshold, and generate an update signal when a difference in size between the first movement and the second movement is larger than a previously set second threshold.

On the other hand, the panoramic video generation unit 400 may generate the update signal when the difference in size between the first movement and the second movement is smaller than the previously set second threshold and a smaller one of the sizes of the first movement and the second movement is larger than a previously set third threshold.

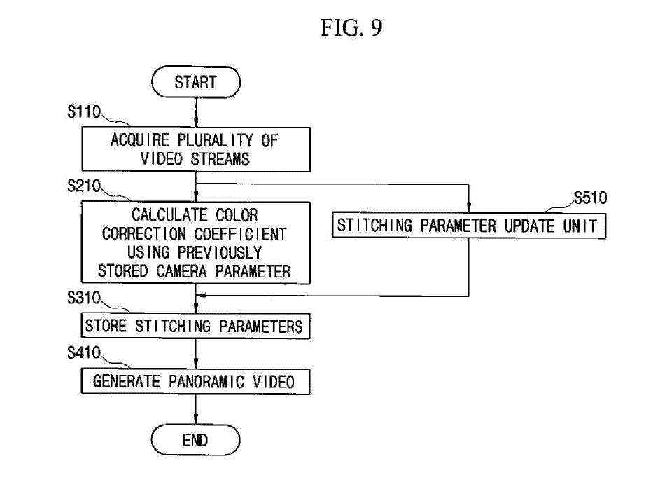

A method of stitching a panoramic video according to the second exemplary embodiment of the present invention will be described below with reference to FIGS. 7 and 9. FIG. 9 is a flowchart illustrating a method of stitching a panoramic video according to the second exemplary embodiment of the present invention.

FIGS. 7 and 9 correspond to an exemplary embodiment in w ich calibration of cameras installed in a structure is performed in advance, and camera parameters are stored in advance.

First, the video acquisition unit 100 acquires a plurality of video streams from a plurality of cameras (S110).

Since camera parameters are known, in a stitching process, the color correction coefficient calculation unit 700 calculates a color correction coefficient for a reference image frame set or a first image frame set (S210) and stores the color correction coefficient as a stitching parameter (S310).

Subsequently, the panoramic video generation unit 400 generates a panoramic video for another input image frame set (S410).

Although the camera parameters have already been known, the stitching parameter update unit 500 updates stitching parameters upon a slight movement of a camera or a change in scene (S510).

According to the exemplary embodiments of the present invention described above, it is possible to perform fast high-performance video stitching for creating a panoramic video. Therefore, a time necessary for photography can be reduced by monitoring panoramic images in real time. Even in the case of an offline work, the creation time of a panoramic video can be reduced, and a performance improvement can be expected.

Also, a reference image frame set having the largest number of feature points is selected, and stitching parameters calculated from the reference image frame set are applied to image composition of another image frame set, so that the amount of computation can be reduced.

Further, when a camera is moved during video capturing due to looseness or collision of a structure, the movement is sensed to update stitching parameters, and the updated stitching parameters are applied to image composition, so that the quality of video stitching can be ensured.

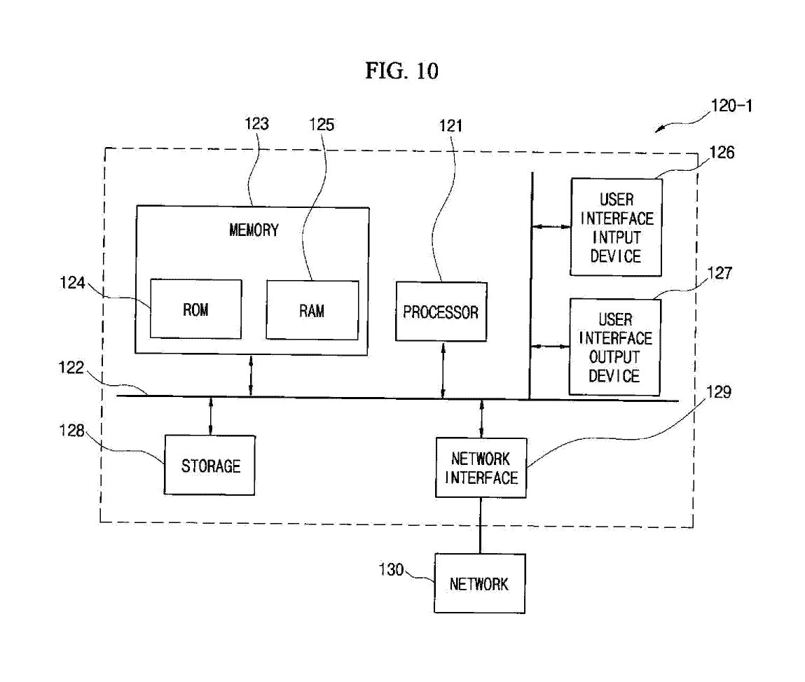

The method for stitching a panoramic video according to an embodiment of the present invention may be implemented in a computer system or may be recorded in a recording medium. FIG. 10 illustrates a simple embodiment of a computer system. As illustrated, the computer system may include one or more processors 121, a memory 123, a user input device 126, a data communication bus 122, a user output device 127, a repository 128, and the like. These components perform data communication through the data communication bus 122.

Also, the computer system may further include a network interface 129 coupled to a network. The processor 121 may be a central processing unit (CPU) or a semiconductor device that processes a command stored in the memory 123 and/or the repository 128.

The memory 123 and the repository 128 may include various types of volatile or non-volatile storage mediums. For example, the memory 123 may include a ROM 124 and a RAM 125.

Thus, the method for stitching a panoramic video according to an embodiment of the present invention may be implemented as a method that can be executable in the computer system. When the method for stitching a panoramic video according to an embodiment of the present invention is performed in the computer system, computer-readable commands may perform the producing method according to the present invention.

The method for stitching a panoramic video according to the present invention may also be embodied as computer-readable codes on a computer-readable recording medium. The computer-readable recording medium is any data storage device that may store data which may be thereafter read by a computer system. Examples of the computer-readable recording medium include read-only memory (ROM), random access memory (RAM), CD-ROMs, magnetic tapes, floppy disks, and optical data storage devices. The computer-readable recording medium may also be distributed over network coupled computer systems so that the computer-readable code may be stored and executed in a distributed fashion.

It will be apparent to those skilled in the art that various modifications can be made to the above-described exemplary embodiments of the present invention without departing from the spirit or scope of the invention. Thus, it is intended that the present invention covers all such modifications provided they come within the scope of the appended claims and their equivalents.

What is claimed is:

1. A method of stitching a panoramic video, the method comprising:
acquiring a plurality of video streams from a plurality of cameras,
selecting a reference image frame set, which is a set of still image frames captured at a first point in time, from the plurality of video streams;
calculating stitching parameters including a camera parameter and a color correction coefficient based on correspondence relationships between feature points extracted from the reference image frame set; and
generating a panoramic video by applying the stitching parameters to another image frame set, which is a set of still image frames captured at a second point in time.

2. The method of claim 1, wherein the selecting of the reference image frame set comprises:
generating point in time-specific image frame sets by combining still image frames captured at the same time in the plurality of video streams,
extracting feature points from still image frames constituting each of the image frame sets; and
selecting an image frame set having a largest number of extracted feature points as the reference image frame set.

3. The method of claim 1, wherein the selecting of the reference image frame set comprises:
generating point in time-specific image frame sets by combining still image frames captured at the same time in the plurality of video streams;
extracting feature points from still image frames constituting each of the image frame sets;
selecting image frame sets whose extracted feature points number a previously set minimum feature point number or more; and
selecting an image frame set having a largest number of extracted feature points from among the selected image frame sets as the reference image frame set.

4. The method of claim 1, wherein the calculating of the stitching parameters comprises:
extracting the feature points from the respective still image frames constituting the reference image frame set;
matching feature points between the still image frames and calculating correspondence relationships;
calculating the camera parameter based on the correspondence relationships; and
calculating the color correction coefficient for equalizing colors of regions overlapping when the still image frames are matched based on the camera parameter.

5. The method of claim 4, wherein the calculating of the camera parameter comprises:
selecting a group of camera parameter candidates resulting in least square errors from at least three feature correspondence points; and
applying the camera parameter candidate group to another feature correspondence point and selecting a camera parameter resulting in a least square error in the camera parameter candidate group.

6. The method of claim 1, wherein the generating of the panoramic video comprises:
converting the still image frames in an x-y coordinate system into converted images in a panoramic image coordinate system using the camera parameter; and
performing color correction by applying the color correction coefficient to the converted images, and then combining the still image frames by summing weights of overlapping regions between the converted images.

7. The method of claim 1, further comprising updating the stitching parameters.

8. The method of claim 7, wherein the updating of the stitching parameters comprises:
generating an update signal at predetermined periods;
extracting feature points from respective still image frames constituting an image frame set corresponding to a point in time at which the update signal is generated;
matching feature points between the still image frames and calculating correspondence relationships;
calculating a camera parameter based on the correspondence relationships; and
calculating the color correction coefficient for equalizing colors of regions overlapping when the still image frames are matched based on the camera parameter.

9. The method of claim 7, wherein the updating of the stitching parameters comprises:
calculating a movement between a previous still image frame (t−1) and a current still image frame (t) in each of the plurality of video streams;
when a size of a first movement between a previous still image frame (t−1) and a current still image frame (t) in a first video stream is larger than a previously set first threshold, calculating a second movement between a previous still image frame (t−1) and a current still image frame (t) in a second video stream; and
when a difference in size between the first movement and the second movement is larger than a previously set second threshold, generating an update signal.

10. The method of claim 9, wherein the updating of the stitching parameters further comprises generating the update signal when the difference in size between the first movement and the second movement is smaller than the previously set second threshold and a smaller one of sizes of the first movement and the second movement is larger than a previously set third threshold.

11. An apparatus for stitching a panoramic video, the apparatus comprising:
a video acquisition unit configured to acquire a plurality of video streams from a plurality of cameras;
a reference image frame set selection unit configured to select a reference image frame set, which is a set of still image frames captured at a first point in time, from the plurality of video streams;
a stitching parameter calculation unit configured to calculate stitching parameters including a camera parameter and a color correction coefficient based on correspondence relationships between feature points extracted from the reference image frame set; and
a panoramic video generation unit configured to generate a panoramic video by applying the stitching parameters to another image frame set, which is a set of still image frames captured at a second point in time.

12. The apparatus of claim 11, wherein the reference image frame set selection unit generates point in time-specific image frame sets by combining still image frames captured at the same time in the plurality of video streams, extracts feature points from still image frames constituting each of the image frame sets, and selects an image frame set having a largest number of extracted feature points as the reference image frame set.

13. The apparatus of claim 11, wherein the reference image frame set selection unit generates point in time-specific image frame sets by combining still image frames captured at the same time in the plurality of video streams, extracts feature points from still image frames constituting each of the image frame sets, selects image frame sets whose extracted feature points number a previously set minimum feature point number or more, and selects an image frame set having a largest number of extracted feature points from among the selected image frame sets as the reference image frame set.

14. The apparatus of claim 11, wherein the stitching parameter calculation unit extracts the feature points from the respective still image frames constituting the reference image frame set, matches feature points between the still image frames to calculate correspondence relationships, calculates the camera parameter based on the correspondence relationships, and calculates the color correction coefficient for equalizing colors of regions overlapping when the still image frames are matched based on the camera parameter.

15. The apparatus of claim 14, wherein the stitching parameter calculation unit selects a group of camera parameter candidates resulting in least square errors from at least three feature correspondence points, and applies the camera parameter candidate group to another feature correspondence point to select a camera parameter resulting in a least square error in the camera parameter candidate group.

16. The apparatus of claim 11, wherein the panoramic video generation unit converts the still image frames in an x-y coordinate system into converted images in a panoramic image coordinate system using the camera parameter, performs color correction by applying the color correction coefficient to the converted images, and then combines the still image frames by summing weights of overlapping regions between the converted images.

17. The apparatus of claim 11, further comprising a stitching parameter update unit configured to update the stitching parameters.

18. The apparatus of claim 17, wherein the stitching parameter update unit comprises:
an update signal generation unit configured to generate an update signal,
an image feature extraction unit configured to extract feature points from respective still image frames constituting an image frame set corresponding to a point in time at which the update signal is generated;
a feature correspondence relationship calculation unit configured to match feature points between the still image frames and calculate correspondence relationships;
a camera parameter calculation unit configured to calculate the camera parameter based on the correspondence relationships; and
a color correction coefficient calculation unit configured to calculate the color correction coefficient for equalizing colors of regions overlapping when the still image frames are matched based on the camera parameter.

19. The apparatus of claim 18, wherein the update signal generation unit generates the update signal at previously set periods.

20. The apparatus of claim 18, wherein the update signal generation unit comprises:
a first movement calculation unit configured to calculate a movement between a previous still image frame (t−1) and a current still image frame (t) in each of the plurality of video streams;
a second movement calculation unit configured to calculate a second movement between a previous still image frame (t−1) and a current still image frame (t) in a second video stream when a size of a first movement between a previous still image frame (t−1) and a current still image frame (t) in a first video stream is larger than a previously set first threshold; and
a movement determination unit configured to determine the first movement and the second movement as abnormal movements when a difference in size between the first movement and the second movement is larger than a previously set second threshold, or when the difference in size between the first movement and the second movement is smaller than the previously set second threshold and a smaller one of sizes of the first movement and the second movement is larger than a previously set third threshold.
